(19) United States
(12) Patent Application Publication
(10) Pub. No.: US 2005/0231621 A1
(43) Pub. Date: Oct. 20, 2005

(54) Integrated image detecting apparatus

(76) Inventors: Wen Hung Su, Pan Chiao City (TW); Chun Ming Hsu, Yungho City (TW); Hung Wen Lin, Ta Li City (TW); Kai Ming Hsiao, Tu Cheng City (TW)

Correspondence Address: BIRCH STEWART KOLASCH & BIRCH, PO BOX 747, FALLS CHURCH, VA, 22040-0747, US

(21) Appl. No.: 10/827,333

(22) Filed: Apr. 20, 2004

(51) Int. Cl. H04N 5/335

(52) U.S. Cl. 348/308

(57) ABSTRACT

The present invention describes an integrated image detecting apparatus with low noise, which transforms optical current to voltage and comprises an optical detecting element, an integrated circuit, a correlated double sampling circuit, and an output circuit. The present invention is a CMOS process and is designed for different CMOS image application systems, which keeps the advantages of low power consumption and better integration. Shifts of circuit characteristics caused by process variation are furthermore eliminated.

### BACKGROUND OF THE INVENTION

1. Field of the Invention

The present invention is an integrated image detecting apparatus, and especially relates to the one integrated image detecting apparatus with low noise transforming optical current to voltage. The problem of deficient sensitivity and high random noise occurred with the high-speed operation of CMOS image chip.

2. Description of Related Art

Data transfer speed between peripheral devices of computer is faster when using a USB 2.0 interface; therefore, a CMOS image chip with a faster operation speed is also needed. Reference is made to U.S. Pat. No. 6,445,022 as shown in FIG. 1, which illustrates a prior art of image sensor circuit, in which an integrated circuit 110 comprises a photodiode 102, an amplifier 104, a capacitor 108 and a switch 114. The integrated circuit 110 transforms optical current signals into voltage signals. The voltage signals will be output by an output terminal 112. The integrated circuit 110 suffers from random noise due to fabrication process variation. Therefore, the signal to noise ratio (S/N) is hard to enhance occurred with the high-speed operation of integrated circuit 110.

### SUMMARY OF THE INVENTION

The present invention provides an integrated image detecting apparatus with low noise, which transforms optical current to voltage and comprises an optical detecting element, an integrated circuit, a correlated double sampling circuit, and an output circuit. The integrated circuit and the correlated double sampling circuit will filter noise of signals output from the optical detecting element, then the S/N ratio will be improved substantially.

### BRIEF DESCRIPTION OF THE DRAWINGS

The various objects and advantages of the present invention will be more readily understood from the following detailed description when read in conjunction with the appended drawing, in which:

FIG. 1 shows a prior art of image sensor circuit;

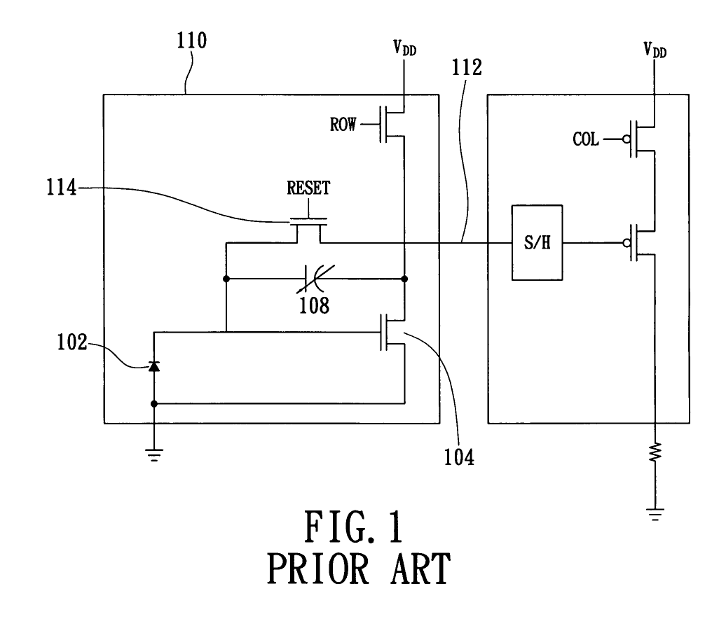

FIG. 2 shows a first embodiment of the present invention;

FIG. 3 shows a second embodiment of the present invention;

FIG. 4 shows a signal diagram of the second embodiment of the present invention;

FIG. 5 shows a third embodiment of the present invention; and

FIG. 6 shows a signal diagram of the third embodiment of the present invention.

### DETAILED DESCRIPTION OF PREFERRED EMBODIMENTS

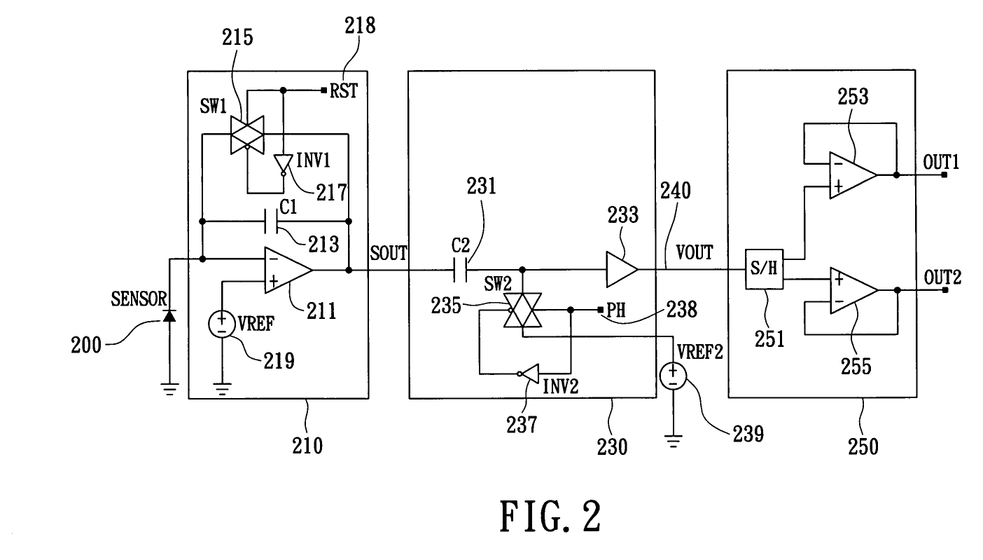

Reference is made to FIG. 2, which shows a first embodiment of the present invention and comprises an optical detecting element 200, an integrated circuit 210, a correlated double sampling circuit 230 and an output circuit 250. The optical detecting element 200 is operated to detect an optical variation and convert the photos into charge, and can be realized by a photodiode and the integrated circuit 210 further comprises an operation amplifier 211, a reference voltage, an electric charge storing device, a CMOS switch 215, and an inverter 217 of CMOS. Where the reference voltage source one 219 is also included that control by external voltage source or a bias provided by certain circuit inside, and the electric charge storing device can be implemented as a capacitor 213. After the optical detecting element 200 transforms the received optical signals into current signals and input the current signals to the amplifier 211, which can be a single stage amplifier instead that consists of NMOS or PMOS transistors. The capacitor 213 is set across a negative input terminal and an output terminal of the amplifier 211. The CMOS switch 215 and the inverter 217 of the CMOS can be the NMOS or PMOS transistors instead, and the CMOS switch 215.is connected in parallel with the inverter 217 and across the negative input terminal and the output terminal of the amplifier 211. A switch signal 218 is used to control the CMOS switch 215.

Connecting a capacitor 231 and a single-stage buffer 233 to the output terminal of the integrated circuit 210 makes up the correlated double sampling circuit 230. Thus, the integrated circuit 210 is operated to convert charge produced by the optical detecting element 200 into electronic signal that is a different type voltage, which comprises a reset voltage operated while the switch turning on inside the integrated circuit 210 and a bright voltage operated while switch turning off inside the integrated circuit 210. The switch includes a NMOS transistor turned on at high voltage and turned off at low voltage or a PMOS transistor turned on at low voltage and turned off at high voltage or a CMOS transistor turned on and turned off at both said high-low voltage. The single-stage buffer 233 is an output-stage buffer for the correlated double sampling circuit 230, which comprised an ac couple device, a CMOS switch, and a unit gain operation amplifier, and connects to read the electronic signal from the output of the integrated circuit 210 for canceling variation of the optical detecting element 200 and of the integrated circuit 210. A CMOS switch 235 and an inverter 237 are connected between the capacitor 231 and the single-stage buffer 233; a switch signal 238 controls a reference voltage source two 239 and it connects to the right of the capacitor 231 which is providing the reference voltage for the capacitor 231. The ac couple device mentioned above can be implemented as a capacitor, and the unit gain operation amplifier can be a single stage amplifier instead that be substituted for a plurality of NMOS or PMOS transistors.

Finally, the output circuit 250 includes a sample and hold circuit device 251 which is connected to an output terminal 240 of the above-mentioned single-stage buffer 233. Then the output circuit 250 performs the output signal of the correlated double sampling circuit and output a plurality of signals. A unit gain buffer 253 and 255 are respectively connected to the sample and hold circuit device 251. Particularly, the CMOS switch mentioned above can be substituted for a NMOS or a PMOS transistor.

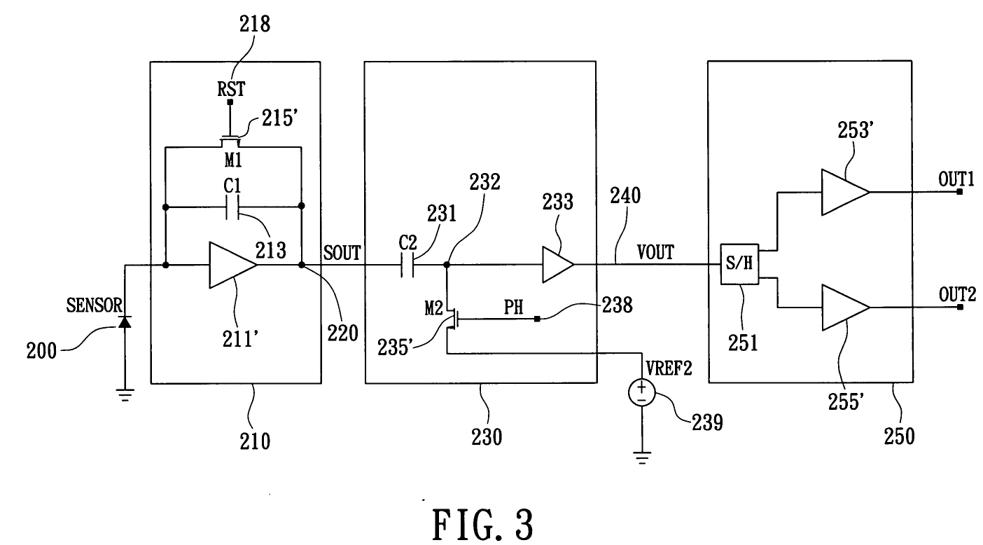

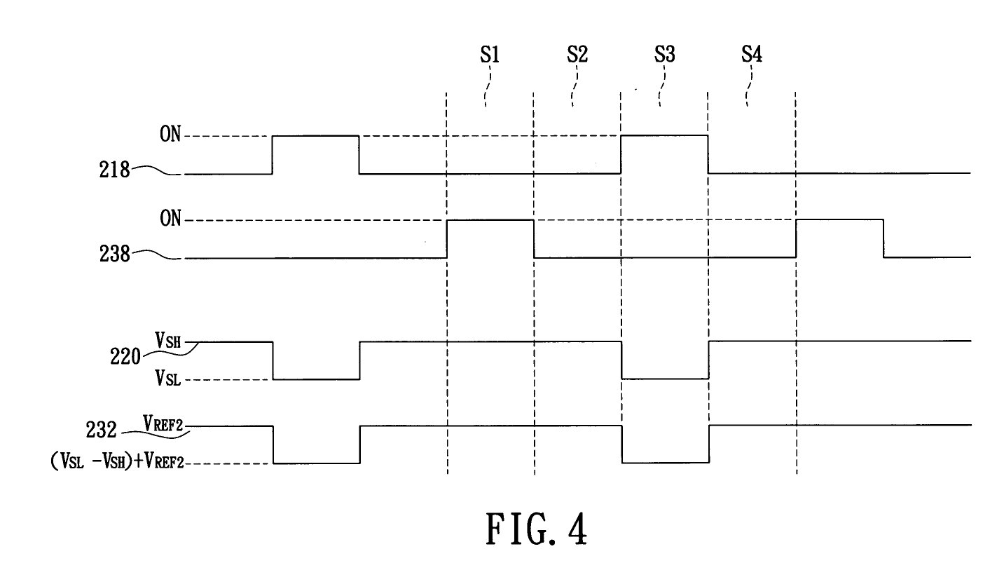

Reference is made to FIG. 3 and FIG. 4. FIG. 3 shows second embodiment of the present invention. The optical detecting element 200 transforms the received optical signals into current signals and inputs the current signals to the amplifier 211′. The voltage of output signals will rise and fall with noise. The second embodiment of present invention is used to eliminate the noise according to following steps:

Step 1 (S1): Activating the switch signal 238 will short the NMOS switch 235′, and an output signal V_{SH} of the optical detecting element 200 is therefore coupled to an output signal 220 of the integrator. At this time, the voltage values at both sides of the capacitor 231 are V_{SH} and V_{REF2}, respectively; the capacitor 231 also stores a voltage value (V_{SH}−V_{REF2}).

Step 2 (S2): The output signal 220 of the integrator is kept at the value V_{SH}. Hence, the voltage value at the right side of the capacitor 231 will be V_{SH}−(V_{SH}−V_{REF2}), and the result of equation is V_{REF2}.

Step 3 (S3): Activating the switch signal 218 will short the switch 215′, and an output signal V_{SH} of the optical detecting element 200 will be changed into V_{SL} and therefore coupled to an output signal 220 of the integrator. The voltage value at the right side of the capacitor 231 will be V_{SL}−(V_{SH}−V_{REF2}), and the result of equation is (V_{SL}−V_{SH})+V_{REF2}.

Step 4 (S4): The output signal 220 of the integrator is changed to V_{SH}. Therefore, the voltage value at the right side of the capacitor 231 will be V_{SH}−(V_{SH}−V_{REF2}), and the result of equation is V_{REF2}.

In steps 1, 2, 4, the voltage value at the right side of the capacitor 231 are V_{REF2}, but in step 3 the voltage value at the right side of the capacitor 231 is (V_{SL}−V_{SH})+V_{REF2}. Fabrication process variation will influence the voltage values V_{SH} and V_{SL}. Due to the result of equation concluded (V_{SL}−V_{SH}), the influence of fabrication process variation and noise signals produced by the circuit and the optical detecting element 200 can be reduced.

The voltage 232 at the right side of the capacitor 231 is processed by the sample and hold circuit device 251 and input to a single-stage buffer 253′ and 255′ for outputting final detecting signals. Maximum signal to noise ratio will be obtained by the above-mentioned method.

The above-mentioned embodiment is demonstrated with a P-sub CMOS process. The switch 215′, 235′ and the unit gain buffer 253, 255 are simplified into the single-stage buffers 253′, 255′ for low cost issue. Otherwise, the switch signals 218 and 238 have high voltage values to turn on the switch 215' and 235′.

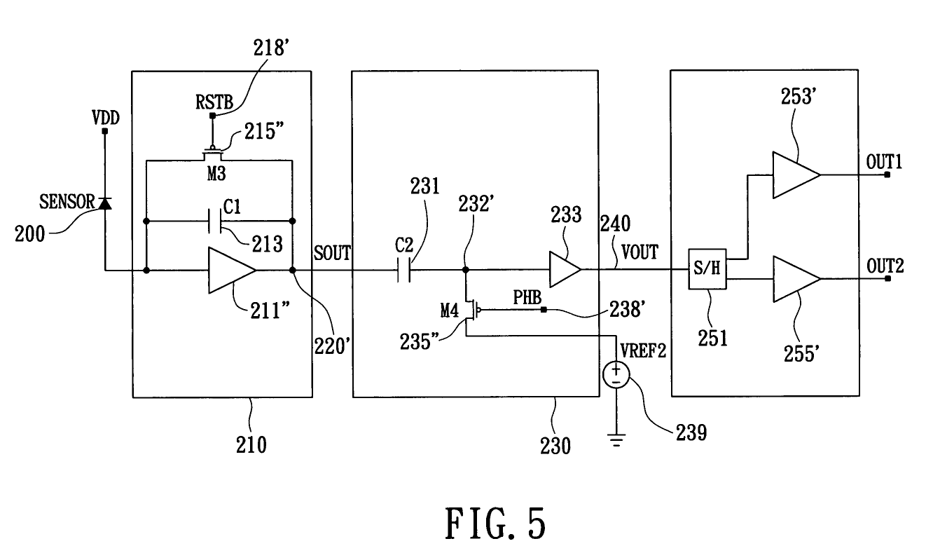

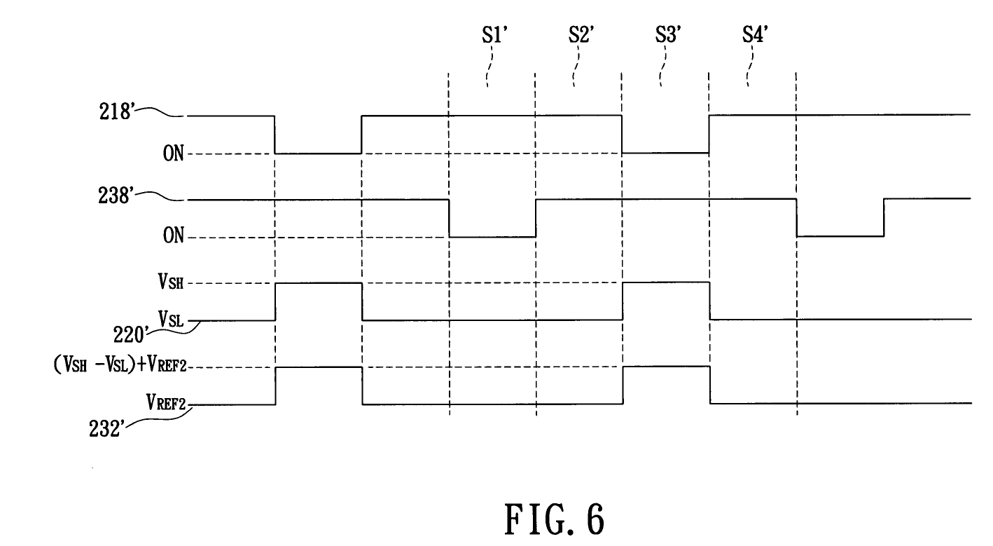

Reference is made to FIG. 5 and FIG. 6. FIG. 5 shows third embodiment of the present invention. The optical detecting element 200 transforms the received optical signals to current signals and inputs the current signals into the amplifier 211′. Output signals will rise and fall with noise. The third embodiment of present invention is also used to eliminate the noise according to following steps:

Step 1 (S1′): Activating the switch signal 238′ will short the PMOS switch 235″, and an output signal V_{SL} of the optical detecting element 200 is therefore coupled to an output signal 220′ of the integrator. At this time, the voltage values at both sides of the capacitor 231 are V_{SL} and V_{REF2}, respectively; the capacitor 231 also stores a voltage value of (V_{SL}−V_{REF2}).

Step 2 (S2′): The output signal 220′ of the integrator is kept at the value V_{SL}. Hence, the voltage value at the right side of the capacitor 231 will be V_{SL}−(V_{SL}−V_{REF2}), and the result of equation is V_{REF2}.

Step 3 (S3′): Activating the switch signal 218′ will short the switch 215″, and an output signal V_{SL} of the optical detecting element 200 will be changed into V_{SH} and coupled to an output signal 220′ of the integrator. The voltage value at the right side of the capacitor 231 will be V_{SH}−(V_{SL}−V_{REF2}), and the result of equation is (V_{SH}−V_{SL})+V_{REF2}.

Step 4 (S4′): The output signal 220′ of the integrator is changed to V_{SL}. Therefore, the voltage value at the right side of the capacitor 231 will be V_{SL}−(V_{SL}−V_{REF2}), and the result of equation is V_{REF2}.

In steps 1, 2 and 4, the voltage values at the right side of the capacitor 231 are all V_{REF2}, but in step 3 the voltage value at the right side of the capacitor 231 is (V_{SH}−V_{SL})+V_{REF2}. Fabrication process variation will influence the voltage values V_{SH} and V_{SL}. Due to the result of equation concluded (V_{SH}−V_{SL}), the influence of fabrication process variation and noise signals produced by the circuit and the optical detecting element 200 can be reduced.

The voltage 232′ at the right side of the capacitor 231 is processed by the sample and hold circuit device 251 and input to a single-stage buffer 253′ and 255′ for outputting final detecting signals. Maximum signal to noise ratio will be obtained by the above-mentioned method.

The above-mentioned embodiment is demonstrated with a N-sub CMOS process. The switch 215″, 235″ are PMOS transistors and the unit gain buffer 253, 255 are simplified into the single-stage buffer 253′, 255′ for low cost issue. Otherwise the switch signals 218′ and 238′ have low voltage values to turn on the switch 215″ and 235″.

Although the present invention has been described with reference to the preferred embodiment therefore, it will be understood that the invention is not limited to the details thereof. Various substitutions and modifications have suggested in the foregoing description, and other will occur to those of ordinary skill in the art. Therefore, all such substitutions and modifications are intended to be embrace within the scope of the invention as defined in the appended claims.

1. An integrated image detecting apparatus used in CMOS process, comprising:
an optical detecting element is operated to detect an optical variation and convert photos into charge;
an integrated circuit is operated to convert charge produced by the optical detecting element into electronic signal that is a different type voltage;
a correlated double sampling circuit connects to read the electronic signal of the integrated circuit output for canceling variation of the optical detecting element and of the integrated circuit; and
an output circuit performs the output signal of the correlated double sampling circuit and output a plurality of signals.

2. The apparatus as claim 1, wherein the optical detecting element is a photodiode adapted for both N-sub and P-sub of CMOS process.

3. The apparatus as claim 1, wherein the integrated circuit comprises an operation amplifier, a reference voltage, an electric charge storing device, a CMOS switch, and an inverter of CMOS.

4. The apparatus as claim 3, wherein the operation amplifier is a single stage amplifier that consists of a NMOS or PMOS transistors, and the reference voltage is an external voltage source or a bias provided by certain circuit inside, and the electric charge storing device is a capacitor, and the CMOS switch and the inverter of CMOS area plurality of NMOS or PMOS transistors.

5. The apparatus as claim 1, wherein the correlated double sampling circuit comprised an ac couple device, a CMOS switch, and a unit gain operation amplifier.

6. The apparatus as claim 5, wherein the ac couple device is a capacitor, and the unit gain operation amplifier is a single stage amplifier that be substituted for a plurality of NMOS or PMOS transistors.

7. The apparatus as claim 1, wherein the output circuit comprises a sample and a hold circuit and a plurality of unit gain operation amplifiers.

8. The apparatus as claim 7, wherein the unit gain operation amplifier is a single stage amplifier that consists of NMOS or PMOS transistors.

9. The apparatus as claim 1, wherein the different type voltage of the output signal for the integrated circuit further comprising:
a reset voltage operated while switch turning on inside the integrated circuit; and
a bright voltage operated while switch turning off inside the integrated circuit.

10. The apparatus as claim 9, wherein the switch includes a NMOS transistor turned on at high voltage and turned off at low voltage, and the switch is a PMOS transistor turned on at low voltage and turned off at high voltage, and the switch is a CMOS transistor turned on and turned off at both said high-low voltage.
